(19) United States
(12) Patent Application Publication
(10) Pub. No.: US 2011/0138800 A1
(43) Pub. Date: Jun. 16, 2011

(54) Electricity-Generating Heat Conversion Device and System

(75) Inventors: Marten Wittorf, Ingelheim (DE); Alan L. Browne, Grosse Pointe, MI (US); Nancy L. Johnson, Northville, MI (US); James Holbrook Brown, Costa Mesa, CA (US)

(73) Assignees: GM GLOBAL TECHNOLOGY OPERATIONS, INC., Detroit, MI (US); DYNALLOY, INC., Costa Mesa, CA (US)

(21) Appl. No.: 12/639,579

(22) Filed: Dec. 16, 2009

(51) Int. Cl. F03G 7/06

(52) U.S. Cl. 60/527

(57) ABSTRACT

A heat conversion device configured for generating electricity and converting thermal energy includes a heat engine configured for converting thermal energy to mechanical energy. The heat engine includes a pseudoplastically pre-strained shape-memory alloy having a crystallographic phase changeable between austenite and martensite in response to thermal energy from a temperature difference between fluids of less than or equal to about 300° C. The heat engine also includes a generator driven by the heat engine and configured for converting mechanical energy to electricity. A heat conversion system configured for generating electricity and converting thermal energy includes a source of thermal energy provided by a temperature difference of less than or equal to about 300° C. between a primary fluid having a first temperature and a secondary fluid having a second temperature that is different from the first temperature, and the heat conversion device.

### TECHNICAL FIELD

The present invention generally relates to energy conversion, and more specifically, to a heat conversion device and system configured for generating electricity and converting thermal energy.

### BACKGROUND OF THE INVENTION

Temperature differences often exist between fluids in a system. For example, a primary fluid may have a comparatively higher temperature than that of a secondary fluid. Such temperature differences therefore provide a source of thermal energy that may be converted to another form of energy.

Additionally, in such systems, thermal energy may also be transferred between the primary fluid and the secondary fluid. That is, the primary fluid may be used to increase the temperature of the secondary fluid, via, for example, a heat conversion device such as a heat exchanger.

### SUMMARY OF THE INVENTION

A heat conversion device configured for generating electricity and converting thermal energy includes a heat engine and a generator. The heat engine is configured for converting thermal energy to mechanical energy in a combination which includes a pseudoplastically pre-strained shape-memory alloy. The shape-memory alloy has a crystallographic phase changeable between austenite and martensite in response to thermal energy from a temperature difference between fluids of less than or equal to about 300° C. The generator is configured for converting mechanical energy to electricity and is driven by the heat engine.

A heat conversion system configured for generating electricity and converting thermal energy includes a source of thermal energy provided by a temperature difference of less than or equal to about 300° C. between a primary fluid having a first temperature and a secondary fluid having a second temperature that is different from the first temperature. The heat conversion system also includes the heat conversion device configured for generating electricity and converting thermal energy. In particular, the heat conversion device includes the heat engine in a combination which includes the pseudoplastically pre-strained shape-memory alloy disposed in heat exchange relationship with each of the primary fluid and the secondary fluid. The heat conversion device also includes the generator driven by the heat engine and configured for converting mechanical energy to electricity.

In one variation, a heat conversion system includes the primary fluid, the secondary fluid, and the heat conversion device. In particular, the heat conversion device has an interior configured for transferring thermal energy between the primary fluid and the secondary fluid. The heat conversion device includes the heat engine that is configured for converting at least some thermal energy to mechanical energy. Further, the heat engine and the generator are disposed within the interior of the heat conversion device. Additionally, the heat conversion system includes an electronic control unit in operable communication with the heat conversion device and configured for regulating transfer of thermal energy between the primary fluid and the secondary fluid. Further, the heat conversion system includes a transfer medium configured for conveying electricity from the heat conversion system.

The heat conversion devices and systems of the present invention provide excellent conversion of thermal energy. Additionally, the heat conversion devices and systems generate electricity. That is, the heat conversion devices and systems may be useful for not only converting thermal energy provided by a temperature difference between fluids, but also for supplying electricity. The heat conversion devices and systems may be scaled to service both household and commercial or industrial applications. And, the heat conversion devices and systems are operable and can generate electricity in response to minimal temperature differences between fluids.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic diagram of a heat conversion system including a heat conversion device; and

FIG. 2 is a schematic perspective view of a generator and a heat engine for combination within the heat conversion device of FIG. 1.

### DESCRIPTION OF THE PREFERRED EMBODIMENTS

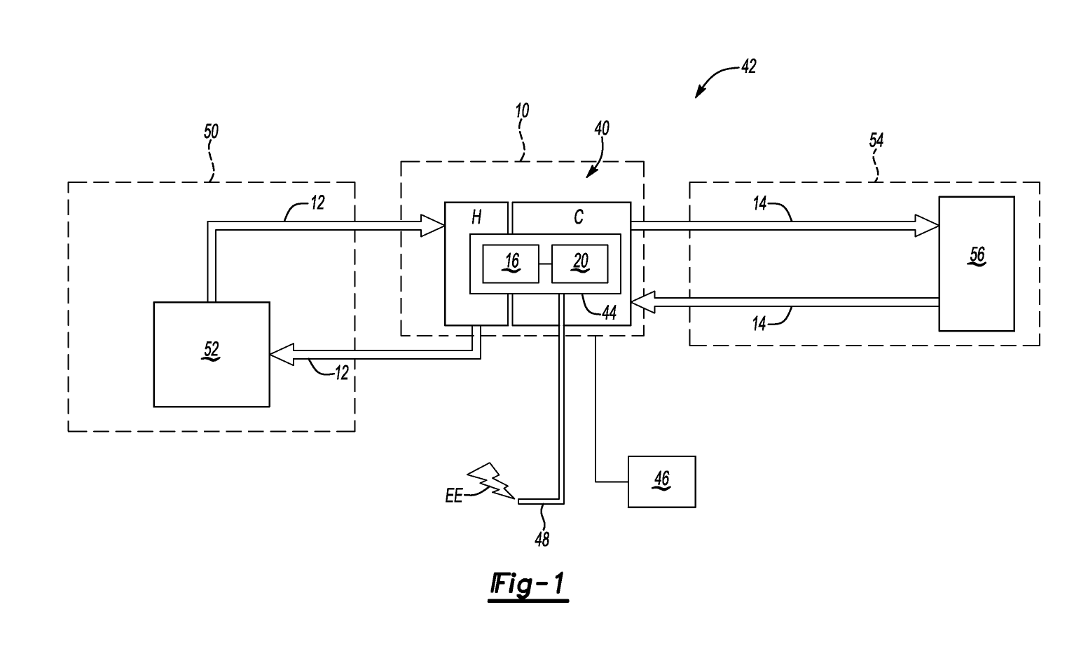

Referring to the Figures, wherein like reference numerals refer to like elements, a heat conversion device is shown generally at 10 in FIG. 1. The heat conversion device 10 is configured for generating electricity and converting thermal energy provided by fluids 12, 14 having a temperature difference, and therefore may be useful for applications such as, but not limited to, household and industrial heating applications. For example, the heat conversion device 10 may be a heat exchanger, and may be useful for heating water in a swimming pool or for providing processing water to a manufacturing facility.

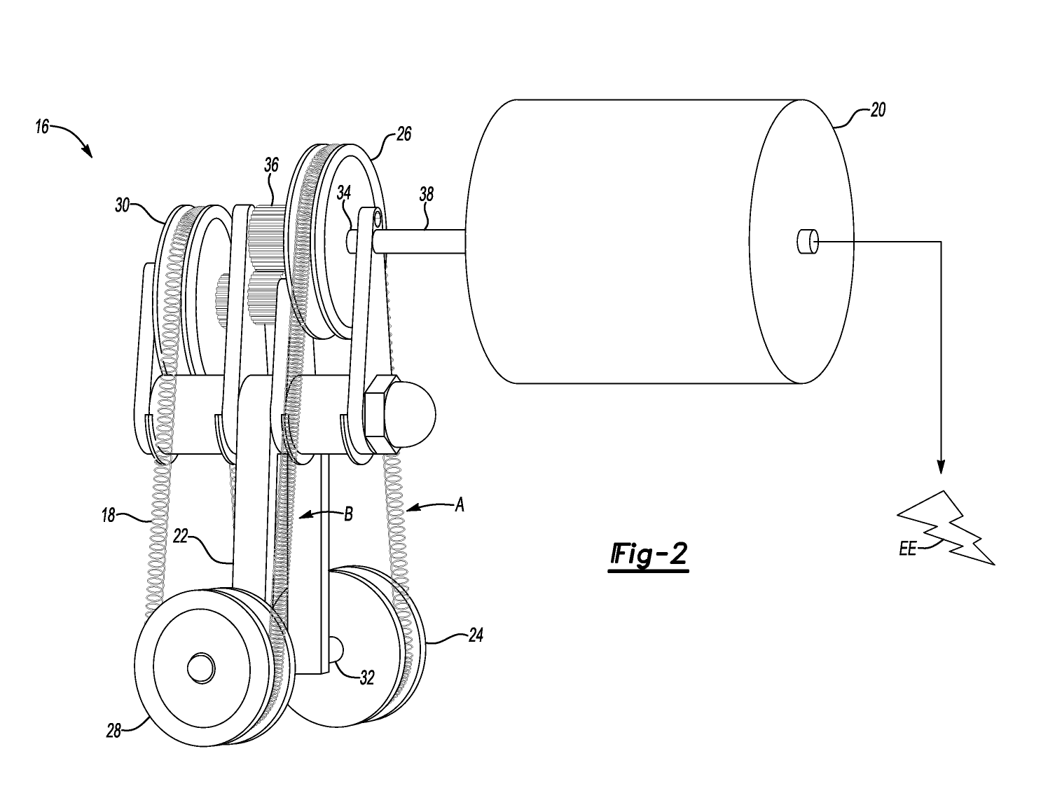

Referring now to FIGS. 1 and 2, the heat conversion device 10 includes a heat engine 16. The heat engine 16 is configured for converting thermal energy, e.g., heat, to mechanical energy, as set forth in more detail below. More specifically, the heat engine 16 includes a pseudoplastically pre-strained shape-memory alloy 18 (FIG. 2) having a crystallographic phase changeable between austenite and martensite in response to the temperature difference of the fluids 12, 14 (FIG. 1). The terminology “pseudoplastically pre-strained” refers to stretching the shape-memory alloy element 18 while the shape-memory alloy 18 is in the martensite phase so that the strain exhibited by the shape-memory alloy 18 under loading is not fully recovered when unloaded. That is, upon unloading, the shape-memory alloy 18 appears to have plastically deformed, but when heated to the austenite start temperature, Aₛ, the strain can be recovered so that the shape-memory alloy 18 returns to the original length observed prior to any load being applied. Additionally, the shape-memory alloy 18 may be stretched before installation in the heat engine 16, such that the nominal length of the shape-memory alloy 18 includes that recoverable pseudoplastic strain, which provides the motion used for driving the heat engine 16.

Further, as used herein, the terminology “shape-memory alloy” refers to known alloys which exhibit a shape-memory effect and have the capability to quickly change properties in terms of stiffness, spring rate, and/or form stability. That is, the shape-memory alloy 18 may undergo a solid state phase change via crystalline rearrangement to shift between a martensite phase, i.e., “martensite”, and an austenite phase, i.e., “austenite”. Stated differently, the shape-memory alloy 18 may undergo a displacive transformation rather than a diffusional transformation to shift between martensite and austenite. In general, the martensite phase refers to the comparatively lower-temperature phase and is often more deformable than the comparatively higher-temperature austenite phase. The temperature at which the shape-memory alloy 18 begins to change from the austenite phase to the martensite phase is known as the martensite start temperature, Mₛ. The temperature at which the shape-memory alloy 18 completes the change from the austenite phase to the martensite phase is known as the martensite finish temperature, M_{f}. Similarly, as the shape-memory alloy 18 is heated, the temperature at which the shape-memory alloy 18 begins to change from the martensite phase to the austenite phase is known as the austenite start temperature, Aₛ. And, the temperature at which the shape-memory alloy 18 completes the change from the martensite phase to the austenite phase is known as the austenite finish temperature, A_{f}.

Therefore, the shape-memory alloy 18 may be characterized by a cold state, i.e., when a temperature of the shape-memory alloy 18 is below the martensite finish temperature M_{f} of the shape-memory alloy 18. Likewise, the shape-memory alloy 18 may also be characterized by a hot state, i.e., when the temperature of the shape-memory alloy 18 is above the austenite finish temperature A_{f} of the shape-memory alloy 18.

In operation, i.e., when exposed to the temperature difference of the fluids 12, 14, the shape-memory alloy 18 can change dimension upon changing crystallographic phase to thereby convert thermal energy to mechanical energy. That is, the shape-memory alloy 18 may change crystallographic phase from martensite to austenite when heated and thereby dimensionally contract if pseudoplastically pre-strained so as to convert thermal energy to mechanical energy. Conversely, the shape-memory alloy 18 may change crystallographic phase from austenite to martensite when cooled and thereby dimensionally expand when under stress so as to be pseudoplastically strained. That is, the shape-memory alloy 18 may dimensionally expand when cooled while under stress so as to reset the shape-memory alloy 18 for another cycle of converting thermal energy to mechanical energy.

The shape-memory alloy 18 may have any suitable composition. In particular, the shape-memory alloy 18 may include in combination an element selected from the group of cobalt, nickel, titanium, indium, manganese, iron, palladium, zinc, copper, silver, gold, cadmium, tin, silicon, platinum, and gallium. For example, suitable shape-memory alloys 18 may include nickel-titanium based alloys, nickel-aluminum based alloys, nickel-gallium based alloys, indium-titanium based alloys, indium-cadmium based alloys, nickel-cobalt-aluminum based alloys, nickel-manganese-gallium based alloys, copper based alloys (e.g., copper-zinc alloys, copper-aluminum alloys, copper-gold alloys, and copper-tin alloys), gold-cadmium based alloys, silver-cadmium based alloys, manganese-copper based alloys, iron-platinum based alloys, iron-palladium based alloys, and combinations of one or more of each of these combinations. The shape-memory alloy 18 can be binary, ternary, or any higher order so long as the shape-memory alloy 18 exhibits a shape memory effect, e.g., a change in shape orientation, damping capacity, and the like. A skilled artisan, in accordance with this invention, may select the shape-memory alloy 18 according to desired operating temperatures of the heat conversion device 10 (FIG. 1), as set forth in more detail below. In one specific example, the shape-memory alloy 18 may include nickel and titanium.

Further, the shape-memory alloy 18 may have any suitable form, i.e., shape. For example, the shape-memory alloy 18 may have a form of a shape-changing element. That is, the shape-memory alloy 18 may have a form selected from the group of springs, tapes, wires, bands, continuous loops, and combinations thereof. Referring to FIG. 2, in one variation, the shape-memory alloy 18 may be formed as a continuous loop spring.

The shape-memory alloy 18 may convert thermal energy to mechanical energy via any suitable manner. For example, the shape-memory alloy 18 may activate a pulley system (shown generally in FIG. 2 and set forth in more detail below), engage a lever (not shown), rotate a flywheel (not shown), engage a screw (not shown), and the like.

Referring again to FIGS. 1 and 2, the heat conversion device 10 also includes a generator 20. The generator 20 is configured for converting mechanical energy to electricity (represented generally by symbol EE in FIGS. 1 and 2). The generator 20 may be any suitable device for converting mechanical energy to electricity EE. For example, the generator 20 may be an electrical generator that converts mechanical energy to electricity EE using electromagnetic induction, and may include a rotor (not shown) that rotates with respect to a stator (not shown).

Referring to FIG. 2, the generator 20 is driven by the heat engine 16. That is, mechanical energy resulting from the conversion of thermal energy by the shape-memory alloy 18 may drive the generator 20. In particular, the aforementioned dimensional contraction and the dimensional expansion of the shape-memory alloy 18 drives the generator 20.

More specifically, in one variation shown in FIG. 2, the heat engine 16 may include a frame 22 configured for supporting one or more wheels or pulleys 24, 26, 28, 30 disposed on a plurality of axles 32, 34. The wheels or pulleys 24, 26, 28, 30 may rotate with respect to the frame 22, and the shape-memory alloy 18 may be supported by, and travel along, the wheels or pulleys 24, 26, 28, 30. Speed of rotation of the wheels or pulleys 24, 26, 28, 30 may optionally be modified by one or more gear sets 36. Moreover, the generator 20 may include a drive shaft 38 attached to the wheel or pulley 26. As the wheels or pulleys 24, 26, 28, 30 turn or rotate about the respective axles 32, 34 of the heat engine 16 in response to the dimensionally expanding and contracting shape-memory alloy 18, the drive shaft 38 rotates and drives the generator 20. The generator 20 then generates electricity EE so that mechanical energy is converted to electricity EE.

Referring generally again to FIG. 1, the heat conversion device 10 may have any suitable configuration, shape, and/or size, depending on the desired application requiring a conversion of thermal energy. For example, the heat conversion device 10 may be a heat exchanger. In general, the heat conversion device 10 may have an interior 40 configured to include a comparatively hot region (represented schematically by area H in FIG. 1) and a comparatively cold region (represented by area C in FIG. 1). The temperature difference between area H and area C allows for transfer of thermal energy between the fluids 12, 14.

The fluids 12, 14 may be in contact in the heat conversion device 10, or may be separated from one another in the heat conversion device 10, so long as thermal energy may be converted to mechanical energy via the heat engine 16. For example, the fluids 12, 14 may be in a heat exchange relationship, i.e., disposed with respect to each other so as to transfer thermal energy to the heat engine 16 for conversion to mechanical energy and/or disposed so as to transfer thermal energy between each other. That is, the heat conversion device 10 may be a shell-and-tube heat exchanger, a plate heat exchanger, a regenerative heat exchanger, a plate fin heat exchanger, a fluid heat exchanger, a waste heat recovery heat exchanger, a dynamic scraped surface heat exchanger, a phase-change heat exchanger, a direct contact heat exchanger, a spiral heat exchanger, and any heat exchange combinations thereof.

In the variation including the heat exchanger as the heat conversion device 10, the heat exchanger may have a configuration of fluid flow selected from the group of parallel-flow, counter-flow, cross-flow, and combinations thereof. As used herein, the terminology “parallel-flow” refers to a configuration in which the fluids 12, 14 each enter a same end of the heat exchanger and travel parallel to each other through the heat exchanger. In contrast, the terminology “counter-flow” refers to a configuration in which the fluids 12, 14 enter the heat exchanger at opposite ends. The terminology “cross-flow” refers to a configuration in which the fluids 12, 14 flow approximately perpendicularly to each other through the heat exchanger. It is further contemplated that the heat conversion device 10 may include other elements such as, but not limited to, filters, valves, baffles, controls, sensors, and pressure regulators.

Referring again to FIG. 1, a heat conversion system is shown generally at 42. The heat conversion system 42 is likewise configured for generating electricity EE and converting thermal energy. More specifically, as shown in FIG. 1, the heat conversion system 42 includes a source of thermal energy provided by a temperature difference between a primary fluid 12 having a first temperature and a secondary fluid 14 having a second temperature that is different from the first temperature. The first temperature may be higher or different than the second temperature. For the heat conversion system 42, the temperature difference is less than or equal to about 300° C. For example, the temperature difference between the first temperature and the second temperature may be as little as about 5° C. and no more than about 100° C. Stated differently, the temperature difference may be greater than or equal to about 5° C. and less than or equal to about 30° C., e.g., less than or equal to about 10° C. Therefore, the shape-memory alloy 18 has a comparatively smaller energy hysteresis than traditional shape-memory alloys, and is responsive to minimal temperature differences. Consequently, the heat engine 16 including the shape-memory alloy 18 can produce comparatively greater output, e.g., mechanical energy and/or electricity EE (FIG. 2), than traditional shape-memory alloys. Stated differently, the heat engine 16 has excellent efficiency and converts a maximum amount of thermal energy to mechanical energy and/or electricity EE, even at a temperature difference of less than or equal to about 10° C., for example. And, as the temperature difference increases, the heat engine 16 and heat conversion device 10 responds more energetically. That is, for comparatively larger temperature differences, the heat engine 16 may convert thermal energy in a shorter amount of time to produce a comparatively larger amount of mechanical energy and/or electricity EE (FIG. 2).

The primary fluid 12 and the secondary fluid 14 may each be selected from the group of gases, liquids, fluidized beds of solids, and combinations thereof. Likewise, the primary fluid 12 may have a different form, i.e., phase, than the secondary fluid 14. For example, the primary fluid 12 may be a liquid and the secondary fluid 14 may be a gas. Further, the primary fluid 12 may be the same as or different from the secondary fluid 14. In one variation, the primary fluid 12 and the secondary fluid 14 may each be water, but the water of the primary fluid 12 may have a first temperature that is higher than the second temperature of the water of the secondary fluid 14.

Referring again to FIG. 1, the heat conversion system 42 also includes the heat conversion device 10. As set forth above, the heat conversion device 10 is configured for generating electricity EE and converting thermal energy. It is to be appreciated that the heat conversion device 10 may transfer only a minimum amount of the thermal energy between fluids 12, 14, but may rather convert a majority of the thermal energy to mechanical energy and/or electricity EE (FIG. 2) via the heat engine 16.

However, in one variation of the heat conversion system 42, the heat conversion device 10 may be the heat exchanger set forth above, and may transfer the majority of the thermal energy between the primary fluid 12 and the secondary fluid 14. That is, the heat conversion device 10 may transfer thermal energy from the primary fluid 12 to the secondary fluid 14 to thereby increase the second temperature of the secondary fluid 14. However, it is to be appreciated that the heat conversion device 10 may alternatively transfer thermal energy from the secondary fluid 14 to the primary fluid 12, depending upon the temperature difference between the primary fluid 12 and the secondary fluid 14.

As shown generally in FIG. 1, the heat engine 16, and more specifically, the shape-memory alloy 18 (FIG. 2) of the heat engine 16, is disposed in heat exchange relationship with each of the primary fluid 12 and the secondary fluid 14. That is, the shape-memory alloy 18 is disposed relative to each of the primary fluid 12 and the secondary fluid 14 so as to react to the first temperature and/or the second temperature via transfer of thermal energy. For example, the shape-memory alloy 18 of the heat engine 16 may be disposed in contact with the primary fluid 12 and the secondary fluid 14. Therefore, the shape-memory alloy 18 may change crystallographic phase between austenite and martensite when in heat exchange relationship with one of the primary fluid 12 and the secondary fluid 14. For example, when in heat exchange relationship with the primary fluid 12, the shape-memory alloy 18 may change from martensite to austenite. Likewise, when in heat exchange relationship with the secondary fluid 14, the shape-memory alloy 18 may change from austenite to martensite.

Further, the shape-memory alloy 18 may change both modulus and dimension upon changing crystallographic phase to thereby convert thermal energy to mechanical energy. More specifically, the shape-memory alloy 18, if pseudoplastically pre-strained, may dimensionally contract upon changing crystallographic phase from martensite to austenite and may dimensionally expand, if under tensile stress, upon changing crystallographic phase from austenite to martensite to thereby convert thermal energy to mechanical energy. Therefore, for any condition wherein the temperature difference ΔT exists between the first temperature of the primary fluid 12 and the second temperature of the secondary fluid 14, i.e., wherein the primary fluid 12 and the secondary fluid 14 are not in thermal equilibrium, the shape-memory alloy 18 may dimensionally expand and contract upon changing crystallographic phase between martensite and austenite. And, the change in crystallographic phase of the shape-memory alloy 18 is sufficient to drive the generator 20.

In operation, with reference to the heat conversion system 42 of FIG. 1 and described with respect to the example configuration of the shape-memory alloy 18 shown in FIG. 2, one wheel or pulley 28 is at least sufficiently immersed in the primary fluid 12 while another wheel or pulley 24 is at least sufficiently immersed in the secondary fluid 14. As one area (generally indicated by arrow A) of the shape-memory alloy 18 dimensionally expands when under stress, e.g., dimensionally stretches when under stress, when in heat exchange relationship with the secondary fluid 14, e.g., when sufficiently immersed in the secondary fluid 14, another area (generally indicated by arrow B) of the pseudoplastically pre-strained shape-memory alloy 18 in heat exchange relationship with the primary fluid 12, e.g., when sufficiently immersed in the primary fluid 12, dimensionally contracts. Alternating dimensional contraction and expansion of the continuous spring loop form of the shape-memory alloy 18 upon exposure to the temperature difference AT between the primary fluid 12 and the secondary fluid 14 may convert potential mechanical energy to kinetic mechanical energy, and thereby convert thermal energy to mechanical energy. Therefore, for optimal efficiency of the heat conversion system 42, the primary fluid 12 and the secondary fluid 14 are preferably rapidly refreshed to maintain the temperature difference AT between the fluids 12, 14.

Referring again to FIG. 1, the heat engine 16 and the generator 20 may be disposed within the interior 40 of the heat conversion device 10. In particular, the heat engine 16 and generator 20 may be disposed in any location within the heat conversion device 10 as long as the heat exchange portions of the shape-memory alloy 18 are disposed in sufficient heat exchange contact with a respective primary fluid 12 and secondary fluid 14. Further, the heat engine 16 and the generator 20 may be surrounded by a housing 44 (FIG. 1). The housing 44 may completely encapsulate the heat engine 16 and the generator 20, or the housing 44 may be vented (not shown). That is, the housing 44 may define cavities (not shown) through which electronic components, such as wires, and/or the primary fluid 12 and the secondary fluid 14 may pass. Further, each cavity may include a filter (not shown) configured for removing impurities from the primary fluid 12 and/or the secondary fluid 14.

It is to be appreciated that the primary fluid 12 and the secondary fluid 14 may not pass through the housing 44. That is, for applications including a liquid primary fluid 12 and a liquid secondary fluid 14, the frame 22 (FIG. 2) of the heat engine 16 may bridge a plate (not shown) that separates the primary fluid 12 from the secondary fluid 14 within the heat conversion device 10. That is, one wheel or pulley 28 may be immersed in the primary fluid 12 while another wheel or pulley 24 may be immersed in the secondary fluid 14. In this configuration, portions of the shape-memory alloy 18 of the heat engine 16 may therefore protrude from a section of the housing 44 sealed with respect to the fluids 12, 14.

Alternatively, the primary fluid 12 and the secondary fluid 14 may pass through the housing 44, but may remain separated within the housing 44. For example, the housing 44 may include inlets and outlets for each of the primary fluid 12 and the secondary fluid 14, and the primary fluid 12 may be separated from the secondary fluid 14 by a seal or barrier.

Although not shown, it is also contemplated that the primary fluid 12 and the secondary fluid 14 may be contained by, and separated within, the housing 44. For example, in this arrangement, the primary fluid 12 and the secondary fluid 14 may each be a liquid or a gas that may be heated or cooled by other fluids passing across the housing 44 during operation of the heat conversion device 10. In this arrangement, the heat engine 16 may be disposed within, for example, a shell (not shown), and adjacent to and in contact with, for example, a tube (not shown) of the heat conversion device 10. Therefore, a comparatively warmer fluid may pass through the tube of the heat conversion device 10 while a comparatively cooler fluid passes through the shell of the heat conversion device 10. The primary fluid 12 and the secondary fluid 14 may thus be warmed and/or cooled by convection or conduction by the fluids within the shell and tube of the heat conversion device 10. The primary fluid 12 and the secondary fluid 14 may be separated within the housing 44, for example by a physical barrier. And, the heat engine 16 may straddle the barrier so that the shape-memory alloy 18 protrudes into each of the primary fluid 12 and the secondary fluid 14.

Referring again to FIG. 1, the heat engine 16 is configured for converting at least some thermal energy to mechanical energy. Any thermal energy not converted to mechanical energy by the heat conversion device 10 may maintain a temperature difference between the first temperature and the second temperature. That is, since the heat engine 16 and the generator 20 are disposed within the interior 40 of the heat conversion device 10 so as to be encapsulated by the heat conversion device 10, heat losses of the heat conversion system 42 are minimized. Any heat generated by expansion and contraction of the shape-memory alloy 18 may transfer to the secondary fluid 14 to increase the second temperature, i.e., heat the secondary fluid 14, or may transfer to the primary fluid 12 to maintain the first temperature. Therefore, the heat conversion system 42 has excellent thermal conversion efficiency.

Referring now to FIG. 1, in one variation, the heat conversion system 42 also includes an electronic control unit 46. The electronic control unit 46 is in operable communication with the heat conversion device 10 and is configured for regulating transfer of thermal energy between the primary fluid 12 and the secondary fluid 14. The electronic control unit 46 may be, for example, a computer that electronically communicates with one or more controls and/or sensors of the heat conversion system 42. For example, the electronic control unit 46 may communicate with and/or control one or more of a temperature sensor of the primary fluid 12, a temperature sensor of the secondary fluid 14, a speed regulator of the generator 20, fluid flow sensors, and meters configured for monitoring electricity generation.

As also shown in FIG. 1, the heat conversion system 42 includes a transfer medium 48 configured for conveying electricity EE from the heat conversion system 42. In particular, the transfer medium 48 may convey electricity EE from the generator 20. The transfer medium 48 may be, for example, a power line or an electrically-conductive cable. The transfer medium 48 may convey electricity EE from the generator 20 to a storage device, e.g., a battery (not shown), an accumulator, and/or a collector, or to an electric power grid of an electric power utility.

Referring again to FIG. 1, the heat conversion system 42 further includes an input circuit, shown generally at 50 in FIG. 1, in fluid communication with the heat conversion device 10 and configured for circulating the primary fluid 12 through the heat conversion device 10. The input circuit 50 may include a reservoir 52, e.g., a boiler or a hot water tank, for storing the primary fluid 12. Further, the input circuit 50 may include piping, valves, pressure regulators, sensors, and combinations thereof to convey the primary fluid 12 between the reservoir 52 and the heat conversion device 10.

Likewise, the heat conversion system 42 further includes an output circuit, shown generally at 54 in FIG. 1, in fluid communication with the heat conversion device 10 and configured for circulating the secondary fluid 14 through the heat conversion device 10. The output circuit 54 may likewise include piping, valves, pressure regulators, sensors, and combinations thereof to convey the secondary fluid 14 between the heat conversion device 10 and an application 56, e.g., swimming pool water or processing water, to be heated.

It is to be appreciated that for any of the aforementioned examples or configurations, the heat conversion device 10 and/or the heat conversion system 42 may include a plurality of heat engines 16 and/or a plurality of generators 20. That is, one heat conversion device 10 may include more than one heat engine 16 and/or generator 20. For example, one heat engine 16 may drive more than one generator 20. Likewise, one heat conversion system 42 may include more than one heat conversion device 10, each including at least one heat engine 16 and generator 20. In variations including more than one heat conversion device 10, the heat conversion devices 10 may be connected in series or in parallel. That is, if a plurality of heat conversion devices 10 are arranged in parallel (not shown), each heat conversion device 10 may be disposed in contact with a common primary fluid 12. Conversely, if a plurality of heat conversion devices 10 are arranged in series (not shown), the primary fluid 12 of one heat conversion device 10 may also be the secondary fluid 14 of another heat conversion device 10.

Heat conversion devices 10 and systems 42 of the present invention provide excellent conversion of thermal energy. Additionally, heat conversion devices 10 and systems 42 generate electricity EE. That is, heat conversion devices 10 and systems 42 may be useful not only for converting thermal energy and/or transferring thermal energy between fluids 12, 14, but also for supplying electricity EE. Heat conversion devices 10 and systems 42 may be scaled to service both household and commercial or industrial applications 56. And, heat conversion devices 10 and systems 42 are operable and can generate electricity EE in response to minimal temperature differences between fluids. As such, heat conversion devices 10 and heat conversion systems 42 harvest thermal energy so as to convert thermal energy to mechanical energy and to electricity EE.

While the best modes for carrying out the invention have been described in detail, those familiar with the art to which this invention relates will recognize various alternative designs and embodiments for practicing the invention within the scope of the appended claims.

1. A heat conversion device configured for generating electricity and converting thermal energy, the heat conversion device comprising:
a heat engine configured for converting thermal energy to mechanical energy and including a pseudoplastically pre-strained shape-memory alloy having a crystallographic phase changeable between austenite and martensite in response to thermal energy from a temperature difference between fluids of less than or equal to about 300° C.; and
a generator configured for converting mechanical energy to electricity and driven by said heat engine.

2. The heat conversion device of claim 1, wherein said temperature difference is less than or equal to about 30° C.

3. The heat conversion device of claim 1, wherein said temperature difference is less than or equal to about 10° C.

4. The heat conversion device of claim 1, wherein said shape-memory alloy changes dimension upon changing crystallographic phase to thereby convert thermal energy to mechanical energy.

5. The heat conversion device of claim 1, wherein said shape-memory alloy changes crystallographic phase from martensite to austenite and thereby dimensionally contracts so as to convert thermal energy to mechanical energy.

6. The heat conversion device of claim 5, wherein said shape-memory alloy changes crystallographic phase from austenite to martensite and thereby dimensionally expands when under stress so as to reset said shape-memory alloy for converting thermal energy to mechanical energy.

7. The heat conversion device of claim 6, wherein said dimensional contraction and said dimensional expansion of said shape-memory alloy drives said generator.

8. The heat conversion device of claim 1, wherein said shape-memory alloy has a form selected from the group of springs, tapes, wires, bands, continuous loops, and combinations thereof.

9. The heat conversion device of claim 1, wherein said shape-memory alloy includes nickel and titanium.

10. The heat conversion device of claim 1, wherein the heat conversion device is a heat exchanger having a configuration of fluid flow selected from the group of parallel-flow, counter-flow, cross-flow, and combinations thereof.

11. A heat conversion system configured for generating electricity and converting thermal energy, the heat conversion system comprising:
a source of thermal energy provided by a temperature difference between a primary fluid having a first temperature and a secondary fluid having a second temperature that is different from said first temperature, wherein said temperature difference is less than or equal to about 300° C.; and
a heat conversion device configured for generating electricity and converting thermal energy, said heat conversion device including;
a heat engine configured for converting thermal energy to mechanical energy and including a pseduoplastically pre-strained shape-memory alloy disposed in heat exchange relationship with each of said primary fluid and said secondary fluid; and
a generator configured for converting mechanical energy to electricity and driven by said heat engine.

12. The heat conversion system of claim 11, wherein said shape-memory alloy changes crystallographic phase between austenite and martensite when in heat exchange relationship with one of said primary fluid and said secondary fluid.

13. The heat conversion system of claim 12, wherein said change in crystallographic phase of said shape-memory alloy drives said generator.

14. The heat conversion system of claim 12, wherein said shape-memory alloy dimensionally contracts upon changing crystallographic phase from martensite to austenite and dimensionally expands when under stress upon changing crystallographic phase from austenite to martensite.

15. The heat conversion system of claim 11, wherein said temperature difference between said first temperature and said second temperature is less than or equal to about 30° C.

16. The heat conversion system of claim 11, wherein said temperature difference between said first temperature and said second temperature is less than or equal to about 10° C.

17. A heat conversion system configured for generating electricity and converting thermal energy, the heat conversion system comprising:
a primary fluid having a first temperature;
a secondary fluid having a second temperature that is different from said first temperature;
a heat conversion device configured for generating electricity and converting thermal energy, wherein said heat conversion device has an interior configured for transferring thermal energy between said primary fluid and said secondary fluid, said heat conversion device including;
a heat engine configured for converting at least some thermal energy to mechanical energy and including a pseudoplastically pre-strained shape-memory alloy disposed in contact with each of said primary fluid and said secondary fluid; and
a generator configured for converting mechanical energy to electricity and driven by said heat engine;
wherein said heat engine and said generator are each disposed within said interior of said heat conversion device;
an electronic control unit in operable communication with said heat conversion device and configured for regulating transfer of thermal energy between said primary fluid and said secondary fluid; and
a transfer medium configured for conveying electricity from the heat conversion system.

18. The heat conversion system of claim 17, wherein any thermal energy not converted to mechanical energy by said heat engine maintains a temperature difference between said first temperature and said second temperature.

19. The heat conversion system of claim 17, further including an input circuit in fluid communication with said heat conversion device and configured for circulating said primary fluid through said heat conversion device, wherein said input circuit includes a reservoir configured for storing said primary fluid at said first temperature.

20. The heat conversion system of claim 19, further including an output circuit in fluid communication with said heat conversion device and configured for circulating said secondary fluid through said heat conversion device.
